(19) United States
(12) Patent Application Publication
(10) Pub. No.: US 2024/0348698 A1
(43) Pub. Date: Oct. 17, 2024

(54) SYSTEM AND METHOD FOR ARTIFICIAL INTELLIGENCE INVESTMENT AND ARTICLE RECOMMENDATIONS

(71) Applicant: Wells Fargo Bank, N.A., San Francisco, CA (US)

(72) Inventors: Jason Matthew Fry, Creve Coeur, MO (US); Aruna Gopinath, St. Louis, MO (US); Justin Morris Krieger, Saint Louis, MO (US); Morgan M. Masters, Charlotte, NC (US); Adam Mark Woiwood, Clive, IA (US)

(21) Appl. No.: 18/299,913

(22) Filed: Apr. 13, 2023

(51) Int. Cl. H04L 67/50; H04L 67/306

(52) U.S. Cl. CPC H04L 67/535; G06Q 40/06; H04L 67/306

(57) ABSTRACT

Various examples are directed to computer-implemented systems and methods for artificial intelligence investment and article recommendations. A method includes receiving a user input indicating values or interests of a user, analyzing the user input to locate and extract preference data from the user input, and tracking activities of the user. Using machine learning, differences between the preference data and the tracked activities are determined to illustrate contradictions by the user, and a recommendation is composed for the user based on the determined differences. The recommendation is displayed on a graphical user interface to assist the user in aligning the activities of the user with the values or interests of the user.

### TECHNICAL FIELD

This document relates generally to computer systems and more particularly to systems and methods for artificial intelligence investment and article recommendations.

### BACKGROUND

Individuals may have values or interests that could factor into their investment decisions. It is sometimes difficult to understand if investment choices are aligned with these values and interests without performing time-consuming research, which may lead to investments being made that inadvertently conflict with values and interests. Improved systems and methods for investment and article recommendations that better support an individual's values or interests are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a method for investment and article recommendations, according to various embodiments;

FIG. 1B illustrates an example embodiment of a method for investment and article recommendations, according to various embodiments;

FIG. 2 illustrates an exemplary infrastructure for use in the present subject matter, according to various embodiments;

FIG. 3 illustrates an example machine learning module for investment and article recommendations, according to various embodiments;

FIG. 4 illustrates a flowchart of a method of training a model for investment and article recommendations, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

Individuals may have values or interests that could factor into their investment decisions. It is sometimes difficult to understand if investment choices are aligned with these values and interests without performing time-consuming research, which may lead to investments being made that inadvertently conflict with values and interests. Improved systems and methods for investment and article recommendations that better support an individual's values or interests are needed.

The present subject matter provides systems and methods for

investment and article recommendations. Various embodiments include receiving a user input indicating values or interests of a user, analyzing the user input to locate and extract investment preference data from the user input, and tracking investment activities of the user. Using machine learning, differences between the preference data and the tracked investment activities are determined to illustrate contradictions between the user-stated/model-determined and actual user values (as shown by existing investment choices), and then an investment, article, or other recommendation is composed for the user based on the differences. The recommendation is displayed on a graphical user interface to assist the user in aligning the investment activities of the user with the values or interests of the user.

The present subject matter provides systems and methods for investment and article recommendations. Various embodiments include receiving a user input indicating values or interests of a user, analyzing the user input to locate and extract preference data from the user input, and tracking activities of the user. Using machine learning, differences between the preference data and the tracked activities are determined to illustrate contradictions by the user, and a recommendation is composed for the user based on the determined differences. The recommendation is displayed on a graphical user interface to assist the user in aligning the activities of the user with the values or interests of the user.

The present system for investment and article recommendations may include a specialized computer system for providing users with an interface to access data within the systems, providing the users with an interface to monitor the system, and may further include customized or dedicated computer storage or memory for the users, in various embodiments.

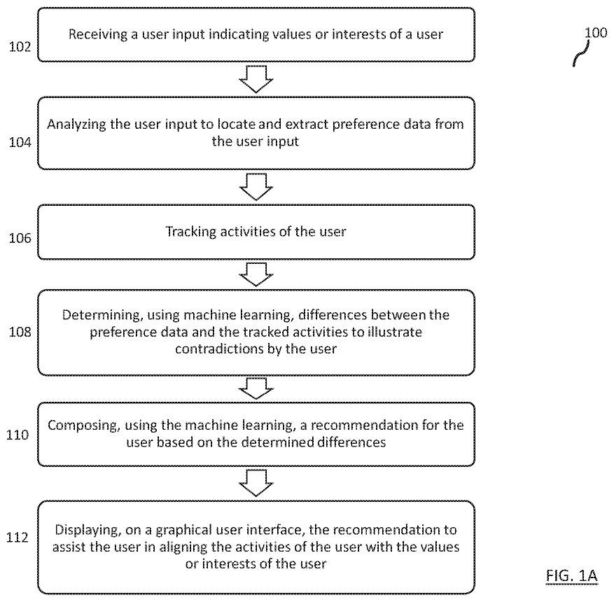

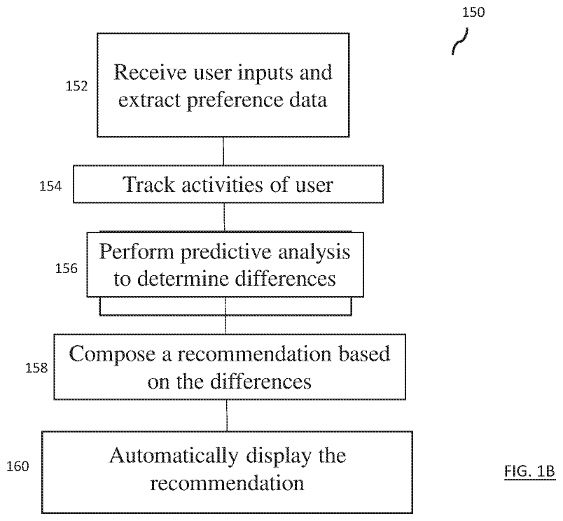

FIG. 1A illustrates an example embodiment of a method for investment and article recommendations, according to various embodiments. The method 100 includes receiving a user input indicating values or interests of a user, at step 102. In some examples, the user input is related to user priorities such as sustainability ratings of an exchange-traded fund (ETF).

At step 104, the method 100 includes analyzing the user input to locate and extract preference data from the user input. The preference data may include investment preference data, in various embodiments. The method 100 further includes tracking activities of the user, at step 106. The activities of the user may be related to user priorities and may include investment activities of the user, in some examples. In some examples, the method further includes automatically adjusting a user investment portfolio based on the recommendation. In various embodiments, the user is prompted to approve the automatic adjustment. In some embodiments, the user may have pre-approved the automatic adjustment if certain thresholds are met, such as fees for the automatic adjustment being less than a threshold amount. The automatic adjustment may include using machine learning, in an embodiment.

The method 100 also include determining, using machine learning, differences between the preference data and the tracked activities to illustrate contradictions by the user, at step 108. In various embodiments, the present system determines differences between the preference data and tracked investment activities to illustrate contradictions between the user-stated/model-determined values and actual user values (as shown by existing investment choices). Using the machine learning includes using a model that is opaque to the user, in various embodiments. In various examples, the method further includes providing an alert to the user based on the determined differences.

At step 110, the method 100 includes composing, using the machine learning, a recommendation for the user based on the determined differences. The recommendation may include an investment recommendation, an article recommendation, and/or other recommendation, in various embodiments. In various examples, using machine learning includes using a machine learning model including one or more of a long short-term memory (LSTM) network, bidirectional encoder representations from transformers (BERT), natural language processing (NLP), or an artificial intelligence (AI)-based knowledge tree.

The method further includes displaying, on a graphical user interface, the recommendation to assist the user in aligning the activities of the user with the values or interests of the user, at step 112. In some examples, displaying the recommendation includes displaying a list of differences between the preference data and investment activities of the user to illustrate contradictions by the user. Displaying the recommendation includes displaying an article recommendation for a news article related to the activities of the user or the user priorities, in some embodiments. In some examples, displaying the article recommendation includes displaying the news article. Displaying the news article includes composing, by the computer system using the machine learning, the news article, in some examples.

FIG. 1B illustrates an example embodiment of a method for investment and article recommendations, according to various embodiments. According to various embodiments, the method 150 may include receiving user inputs and extracting preference data, such as investment preference data, at step 152. In some examples, the user inputs are related to user priorities such as sustainability ratings of an exchange-traded fund (ETF). Other user priorities may be used without departing from the scope of the present subject matter.

The method 150 may also include tracking activities of the user, at step 154. The activities of the user include investment activities of the user, in some examples. In some examples, the method further includes automatically adjusting, using machine learning, a user investment portfolio based on the recommendation. In various embodiments, the user is prompted to approve the automatic adjustment. In some embodiments, the user may have pre-approved the automatic adjustment if certain thresholds are met, such as fees for the automatic adjustment being less than a threshold amount. In various examples, using machine learning includes using a machine learning model including one or more of a long short-term memory (LSTM) network, bidirectional encoder representations from transformers (BERT), natural language processing (NLP), or an artificial intelligence (AI)-based knowledge tree.

The method 150 continues at step 156, where predictive analysis is performed to determine differences between the preference data and the tracked activities, in various examples. In various embodiments, the present system determines differences between the preference data and tracked investment activities to illustrate contradictions between the user-stated/model-determined values and actual user values (as shown by existing investment choices). The predictive analysis may include using machine learning using a model that is opaque to the user, in various embodiments. In various examples, the method further includes providing an alert to the user based on the determined differences.

At step 158, the method 150 may include composing a recommendation using machine learning based on the differences, in various embodiments. The recommendation may include an investment recommendation, an article recommendation, and/or other recommendation, in various embodiments. At step 160, the method may include automatically displaying the recommendation on a graphical user interface, in various embodiments. In some examples, displaying the recommendation includes displaying a list of differences between the preference data and the tracked activities to illustrate contradictions by the user. Displaying the recommendation includes displaying an article recommendation for a news article related to the activities of the user or the user priorities, in some embodiments. In some examples, displaying the article recommendation includes displaying the news article. Displaying the news article includes composing, by the computer system using the machine learning, the news article, in some examples.

In various embodiments, the present subject matter provides for artificial intelligence (AI) investment and article recommendations where the investor (or user) can specify interests and receive recommended investments or articles to read. The AI can learn investor interests over time and apply them automatically, in various examples.

In some embodiments, the present system may make recommendations based on sustainability ratings for ETFs, which may be based on for example, supply chains, worker conditions, safe for LGBTQ+, etc. The present system may make determinations such as “existing sustainability ratings are corrupt” (green washing), and provide feedback that independent ratings are needed. For example, the system may determine that activities of a company that is part of an investment are not as sustainable as their sustainability ratings indicate, such that an independent sustainability rating should be generated to reflect a more accurate rating. The system may prompt the user to generate an independent rating, or may automatically generate the rating, in various embodiments. In various examples, a user's personal values may be used as part of a selection or recommendation. Input to the system may include priority ratings by the user, in various examples, which may include fees associated with an investment, return on investment (ROI), personal values, etc. In various embodiments, the AI may learn that the user is actually valuing ROI over what they claim to want (e.g., sustainability) based on the user input. A user interface (UI) may be provided to show what the user prioritizes and also show the investment's ROI to provide the user with options with respect to economic and non-economic user priorities.

Another aspect of the present subject matter may include an AI system that provides investment advice to the user, and may also draft articles or retrieve articles based on predictive analysis. In various examples, the system may search available databases to gather information and create text from the gathered information for article generation. The present system may include machine learning or AI that can write recommendation text, in various embodiments. For example, the system may use a large language model (LLM) such as Chat GPT to generate the articles, in various embodiments.

The present subject matter may include showing a value-agnostic suggestion to compare a current user investment portfolio with the historical record of other non-value based selections of investment options. For example, the system may provide investment suggestions that are not related to a user's stated priorities for comparison with other investors. In some embodiments, the present system may provide a display for a financial advisor of the user, so they can recommend appropriate investments for the user. In one embodiment, a value-agnostic recommendation may be presented with a value-based recommendation on a display to illustrate to the user a difference in return that the user's value-based choice would cost, which may be used justify a values-based investment purchase if the difference is not that large.

In various embodiments, the present system provides for machine learning to determine sustainability of investment options in a manner that is opaque to the user. In some embodiments, the present system may consider whether companies that are subjects of potential investing participate in self-reporting of factors that may be important to a user, such as diversity, equity and inclusion (DEI) lists, etc. In various examples, the present system automates sustainability ratings considering these additional factors related to self-reporting. When a user sets up an investment account, the user may prioritize wants for investing. The present system may then analyze user investment activity and use AI to evaluate and compare a user's stated values with a user's actual choices, and may provide feedback to the user to show how their investment choices align with their stated values.

According to various examples, the present system provides AI-based output to show a user current and projected portfolio alignment with stated values-based priorities of the user. For example, if a user always selects high ROI over a stated value of a sustainability factor, then the user is investing differently than they claim they want to invest. The present system may provide the user feedback based on selections, or may automatically redirect investments based on the analysis, in various embodiments.

Various embodiments of the present subject matter provide AI article recommendations and/or article writing. The present subject matter may provide sustainability ratings for ETFs based on an AI-generated value statement for a user based on user data (not based on active user selection), that is opaque to the user, in various embodiments. In various embodiments, the present subject matter may provide an AI presentation of a user's stated values compared to what a user's choices indicate. The present system may provide AI that tracks what a user is actually doing (e.g., in daily purchases, stock/ETF purchases, etc.) compared to what the user intends to do or says they are doing, in various embodiments. For example, a user may indicate that they support sustainability, but constantly order takeout that creates extra trash. The user may not be aware of this behavior, and the AI may suggest that the user offset this by investing in green companies. In another example, a user may not know that the user's ETF includes a defense manufacturer when the user has identified a value statement as being against war. The present system may include an AI/ML model that is opaque to the user, does not use a user's explicit statements, and/or relies only on background data, for example.

The present AI recommendation system may be provided generally to the public, or may be restricted to new investors or new potential customers, in various examples. According to various embodiments, the present system may make investment recommendations within a particular sector, or provide article generation, doing research based on user input or risk tolerance, and bringing research to the user. The present system may use natural language processing, in various examples, to provide or replicate a normal conversation of a financial advisor with a client or user, in various examples. User input may include, but is not limited to, a user's goals, risk, values, kinds of companies the user wants to support with investment, kinds of companies the user wants to avoid supporting (no fossil fuels, no exploiting child labor, etc.), and the like.

According to various embodiments, the present subject matter may provide a user display to offer options, risk ratings, sustainability index scores and prospectus-based historical returns of different funds available to a user. If the user continues to purchase shares in particular types of funds, the AI may track user activity across their portfolio to show more of types of funds the user actually selects, in an embodiment. In various embodiments, the present system may be used by a user that prioritizes environmental, social, and governance (ESG) investing. ESG investing is a way of investing in companies based on their commitment to one or more ESG factors, such as sustainable investing or socially responsible investing. The present system may compare a user's investments based on growth or return-driven investments and compare with ESG ratings to allow a user to align investments with goals, in various embodiments.

In some examples, the present system may provide a user with educational materials and articles based on user investment activity and stated priorities. The system may recommend investment vehicles and strategies, and deliver articles of interest based on what a user indicates they value and based on the user's actual behavior and investments. In various embodiments, the system may provide performance-related information and/or sector-related information, to allow the user to adjust (or to automatically adjust) the user's portfolio on an ongoing basis to change investments, provide educational packages, or present additional recommendations. In various embodiments, the user is prompted to approve the automatic adjustment. In some embodiments, the user may have pre-approved the automatic adjustment if certain thresholds are met, such as fees for the automatic adjustment being less than a threshold amount.

In some examples, the present system provides balance or hybridization between AI and self-directed investment choices and strategies to consider. For example, the system may provide suggestions for investments or articles that are generated by machine learning, as well as providing suggestions that are based on a user's previous pattern of self-directed investment choices for comparison. The system may provide investment advice in a format similar to that provide by a financial advisor, in various embodiments. In some embodiments, the present subject matter provides a chat-bot for the user to ask questions and obtain feedback for investment decisions. Thus, a user may benefit by obtaining financial advisor-type feedback without paying financial advisor fees, and by being able to track how their investments align with their stated values.

The present system provides additional benefits to the user by examining investment choices and identifying companies or investments that have stated values that do not match their activities, so-called green-washing. The present system uses AI to research and determine if such contradictions exist, and provide notice to the user. For example, a company may indicate that it is environmentally friendly, but may have recently purchased a subsidiary that is not environmentally friendly. The present system may train a learning model to look activity by a company or investment vehicle that is out of step with stated purposes, such as donations made to certain causes or employment of child labor, for example. This activity then may be flagged and the user may be alerted, in various embodiments.

In various embodiments, inputs to the system may include a user's stated investment objectives or types of investments, such as stocks, mutual funds, EFTs, and the like. The present system provides not only ratings of companies or investments, but the system also goes beyond the ratings and looks at what standards a company adheres to in its activities and supply chains. The system may compose and deliver articles that educate the user about how sustainability ratings are accurate or not for various investments. The system may make recommendations of investments or articles to read for the user, in various embodiments. The present system may provide its own definitions of ESG, such as an AI-created rating of funds, in various embodiments. The system may also examine company activity and flag a company if its publicly available rating does not align with company activity.

In some examples, the present system may determine how other users are investing based on similar information, and look at historical choices of a plurality of users, to help to determine recommendations for a current user, similar to crowdsourcing. For example, the system may inform the user how other investors have acted when presented with a similar situation. Calculations and predictions used herein may include using a blockchain, smart contracts, or machine learning, in various embodiments.

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1A-1B. In some examples, the machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. Other types of machine learning models may be used without departing from the scope of the present subject matter. In some examples, the present platform may use a blockchain and/or smart contracts to implement the investment and article recommendations.

Various embodiments include a non-transitory computer-readable storage medium, the non-transitory computer-readable storage medium including instructions that, when executed by computers, cause the computers to perform operations including the methods of FIGS. 1A-1B. In various embodiments, the present system runs simulations to train the machine learning models, and to identify process improvements and optimization for investment and article recommendations. Training of the models may be accomplished online or offline, in various embodiments. According to various embodiments, the method may include using artificial intelligence.

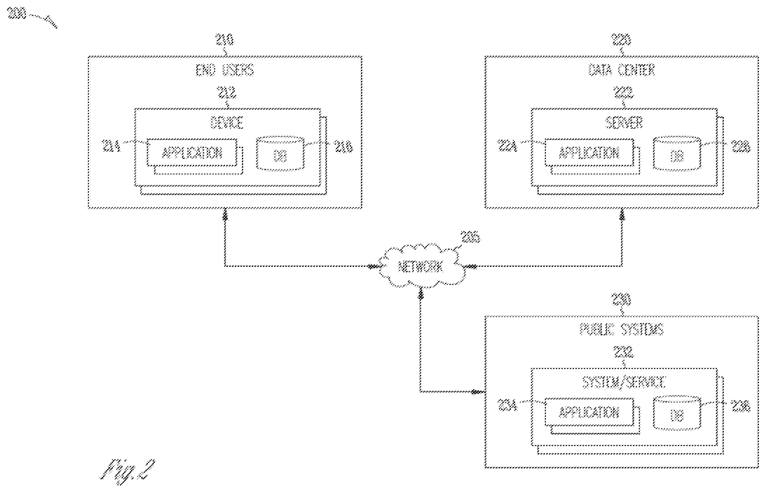

FIG. 2 illustrates an exemplary infrastructure for providing a system of the present subject matter. The infrastructure may comprise a distributed system 200 including a computing system that may include a client-server architecture or cloud computing system. Distributed system 200 may have one or more end users 210. An end user 210 may have various computing devices 212, which may be a machine 500 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The server 222 or other portions of the distributed system may create and manage the system for investment and article recommendations, such as by performing operations including the methods of FIGS. 1A-1B, in various embodiments. The business entity may be a computer service provider, as may be the case for a cloud services provider, or it may be a consumer product or service provider, such as a financial institution. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 500.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 500.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

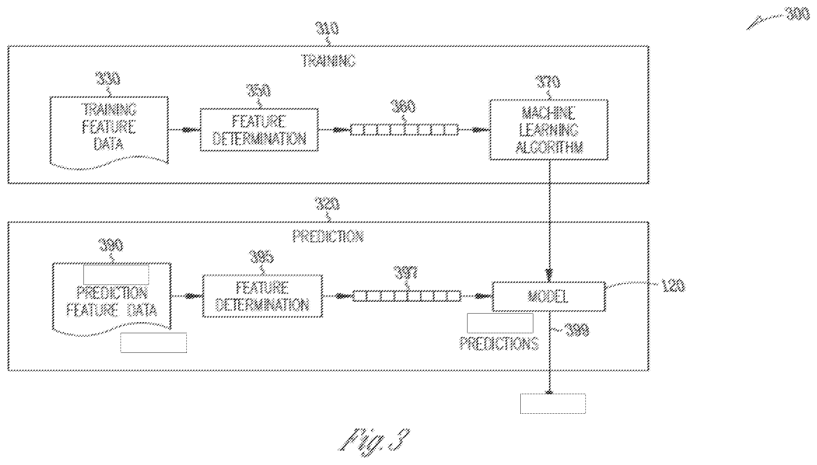

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of user-specific investment and article recommendations. Categories of training feature data may include tracked user data, input user data, news articles, social media data, other third-party data, or the like. Specific training feature data and prediction feature data 390 may include, for example one or more of: current tracked user data, past tracked user data, and the like.

Feature determination module 350 selects training vector 360 from the training feature data 330. The selected data may fill training vector 360 and comprises a set of the training feature data that is determined to be predictive of user-specific investment and article recommendations. In some examples, the tasks performed by the feature determination module 350 may be performed by the machine learning algorithm 370 as part of the learning process. Feature determination module 350 may remove one or more features that are not predictive of user-specific investment and article recommendations to train the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as sustainability of funds in a user investment portfolio. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method. In various embodiments, smart contracts or blockchain may be used to calculate and/or implement user-specific investment and article recommendations.

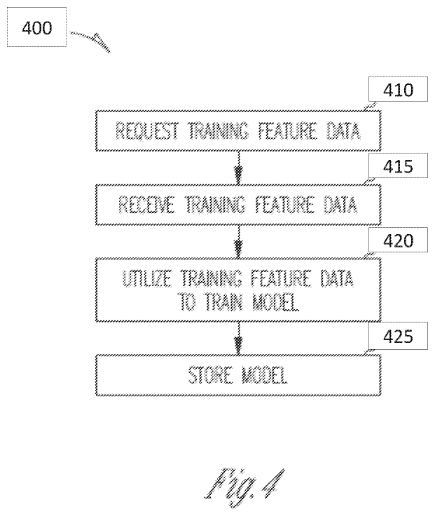

FIG. 4 illustrates a flowchart of a method 400 of training a model for investment and article recommendations, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions.

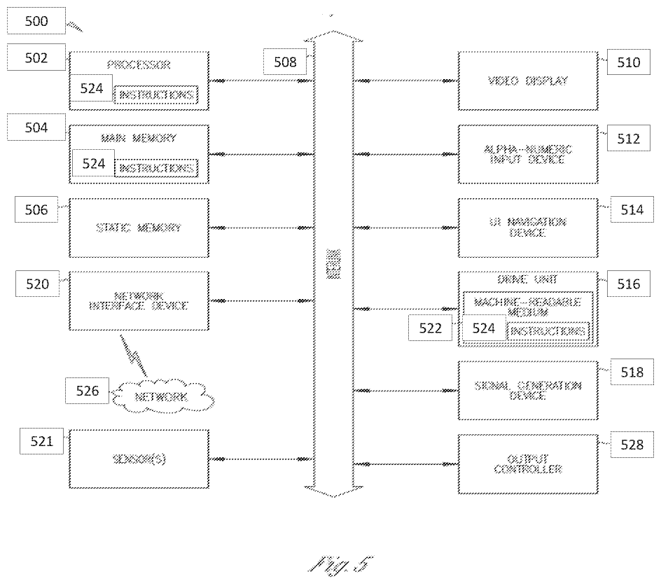

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may implement one or more of the training and prediction modules 310, 320 (e.g., as software or dedicated hardware) and may be configured to perform the methods of FIGS. 1A, 1B and 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers

(IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### OTHER NOTES AND EXAMPLES

Example 1 is a computer-implemented method including receiving, by a computer system, a user input indicating values or interests of a user, analyzing, by the computer system, the user input to locate and extract preference data from the user input, tracking, by the computer system, activities of the user, determining, by the computer system using machine learning, differences between the preference data and the tracked activities to illustrate contradictions by the user, composing, by the computer system using the machine learning, a recommendation for the user based on the determined differences, and displaying, on a graphical user interface in communication with the computer system, the recommendation to assist the user in aligning the activities of the user with the values or interests of the user.

In Example 2, the subject matter of Example 1 optionally includes wherein the user input is related to sustainability ratings of an exchange-traded fund (ETF).

In Example 3, the subject matter of Example 1 optionally includes wherein the activities of the user include investment activities of the user.

In Example 4, the subject matter of Example 3 optionally further includes automatically adjusting, by the computer system using the machine learning, a user investment portfolio based on the recommendation.

In Example 5, the subject matter of Example 1 optionally includes wherein displaying the recommendation includes displaying a list of differences between the preference data and the tracked activities to illustrate contradictions by the user.

In Example 6, the subject matter of Example 1 optionally includes wherein using the machine learning includes using a machine learning model including one or more of a long short-term memory (LSTM) network, bidirectional encoder representations from transformers (BERT), natural language processing (NLP), or an artificial intelligence (AI)-based knowledge tree.

In Example 7, the subject matter of Example 1 optionally includes wherein displaying the recommendation includes displaying an article recommendation for a news article related to the activities of the user.

In Example 8, the subject matter of Example 7 optionally includes wherein displaying the article recommendation includes displaying the news article.

In Example 9, the subject matter of Example 8 optionally includes wherein displaying the news article includes composing, by the computer system using the machine learning, the news article.

Example 10 is a system including: a computing system comprising one or more processors and a data storage system in communication with the one or more processors, wherein the data storage system comprises instructions thereon that, when executed by the one or more processors, causes the one or more processors to: receive a user input indicating values or interests of a user, analyze the user input to locate and extract preference data from the user input, track activities of the user, determine, using machine learning, differences between the preference data and the tracked activities to illustrate contradictions by the user, compose, using the machine learning, a recommendation for the user based on the determined differences, and display, on a graphical user interface, the recommendation to assist the user in aligning the activities of the user with the values or interests of the user.

In Example 11, the subject matter of Example 10 optionally includes

wherein the machine learning includes a machine learning model including a neural network.

In Example 12, the subject matter of Example 11 optionally includes wherein the neural network includes a long short-term memory (LSTM) network.

In Example 13, the subject matter of Example 10 optionally includes wherein the machine learning includes bidirectional encoder representations from transformers (BERT).

In Example 14, the subject matter of Example 10 optionally includes wherein the machine learning includes natural language processing (NLP).

In Example 15, the subject matter of Example 10 optionally includes wherein the machine learning includes an artificial intelligence (AI)-based knowledge tree.

Example 16 is a non-transitory computer-readable storage medium, the non-transitory computer-readable storage medium including instructions that, when executed by computers, cause the computers to perform operations of: receiving a user input indicating values or interests of a user, analyzing the user input to locate and extract preference data from the user input, tracking activities of the user, determining, using machine learning, differences between the preference data and the tracked activities to illustrate contradictions by the user, composing, using the machine learning, a recommendation for the user based on the determined differences, and displaying, on a graphical user interface, the recommendation to assist the user in aligning the activities of the user with the values or interests of the user.

In Example 17, the subject matter of Example 16 optionally includes wherein the medium further includes instructions that, when executed by computers, cause the computers to perform operations of providing an alert to the user based on the determined differences.

In Example 18, the subject matter of Example 16 optionally includes wherein using machine learning includes using a machine learning model including one or more of a long short-term memory (LSTM) network, bidirectional encoder representations from transformers (BERT), natural language processing (NLP), or an artificial intelligence (AI)-based knowledge tree.

In Example 19, the subject matter of Example 16 optionally includes wherein the activities of the user include investment activities of the user.

In Example 20, the subject matter of Example 16 optionally includes wherein the medium further includes instructions that, when executed by computers, cause the computers to perform operations of automatically adjusting, using the machine learning, a user investment portfolio based on the recommendation.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72 (b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A computer-implemented method comprising:
receiving, by a computer system, a user input indicating values or interests of a user;
analyzing, by the computer system, the user input to locate and extract preference data from the user input;
tracking, by the computer system, activities of the user;
determining, by the computer system using machine learning, differences between the preference data and the tracked activities to illustrate contradictions by the user;
composing, by the computer system using the machine learning, a recommendation for the user based on the determined differences; and
displaying, on a graphical user interface in communication with the computer system, the recommendation to assist the user in aligning the activities of the user with the values or interests of the user.

2. The computer-implemented method of claim 1, wherein the user input is related to sustainability ratings of an exchange-traded fund (ETF).

3. The computer-implemented method of claim 1, wherein the activities of the user include investment activities of the user.

4. The computer-implemented method of claim 3, further comprising:
automatically adjusting, by the computer system using the machine learning, a user investment portfolio based on the recommendation.

5. The computer-implemented method of claim 1, wherein displaying the recommendation includes displaying a list of differences between the preference data and the tracked activities to illustrate contradictions by the user.

6. The computer-implemented method of claim 1, wherein using the machine learning includes using a machine learning model including one or more of a long short-term memory (LSTM) network, bidirectional encoder representations from transformers (BERT), natural language processing (NLP), or an artificial intelligence (AI)-based knowledge tree.

7. The computer-implemented method of claim 1, wherein displaying the recommendation includes displaying an article recommendation for a news article related to the activities of the user.

8. The computer-implemented method of claim 7, wherein displaying the article recommendation includes displaying the news article.

9. The computer-implemented method of claim 8, wherein displaying the news article includes composing, by the computer system using the machine learning, the news article.

10. A system comprising:
a computing system comprising one or more processors and a data storage system in communication with the one or more processors, wherein the data storage system comprises instructions thereon that, when executed by the one or more processors, causes the one or more processors to:
receive a user input indicating values or interests of a user;
analyze the user input to locate and extract preference data from the user input;
track activities of the user;
determine, using machine learning, differences between the preference data and the tracked activities to illustrate contradictions by the user;
compose, using the machine learning, a recommendation for the user based on the determined differences; and
display, on a graphical user interface, the recommendation to assist the user in aligning the activities of the user with the values or interests of the user.

11. The system of claim 10, wherein the machine learning includes a machine learning model including a neural network.

12. The system of claim 11, wherein the neural network includes a long short-term memory (LSTM) network.

13. The system of claim 10, wherein the machine learning includes bidirectional encoder representations from transformers (BERT).

14. The system of claim 10, wherein the machine learning includes natural language processing (NLP).

15. The system of claim 10, wherein the machine learning includes an artificial intelligence (AI)-based knowledge tree.

16. A non-transitory computer-readable storage medium, the non-transitory computer-readable storage medium including instructions that, when executed by computers, cause the computers to perform operations of:
receiving a user input indicating values or interests of a user;
analyzing the user input to locate and extract preference data from the user input;
tracking activities of the user;
determining, using machine learning, differences between the preference data and the tracked activities to illustrate contradictions by the user;
composing, using the machine learning, a recommendation for the user based on the determined differences; and
displaying, on a graphical user interface, the recommendation to assist the user in aligning the activities of the user with the values or interests of the user.

17. The non-transitory computer-readable storage medium of claim 16, wherein the medium further includes instructions that, when executed by computers, cause the computers to perform operations of:
providing an alert to the user based on the determined differences.

18. The non-transitory computer-readable storage medium of claim 16, wherein using machine learning includes using a machine learning model including one or more of a long short-term memory (LSTM) network, bidirectional encoder representations from transformers (BERT), natural language processing (NLP), or an artificial intelligence (AI)-based knowledge tree.

19. The non-transitory computer-readable storage medium of claim 16, wherein the activities of the user include investment activities of the user.

20. The non-transitory computer-readable storage medium of claim 19, wherein the medium further includes instructions that, when executed by computers, cause the computers to perform operations of:
automatically adjusting, using the machine learning, a user investment portfolio based on the recommendation.
